(19) United States
(12) Patent Application Publication
(10) Pub. No.: US 2013/0249671 A1
(43) Pub. Date: Sep. 26, 2013

(54) Warning System and Method for Operating a Warning System

(71) Applicant: mecom Medien-Communikations-Gesellschaft mbH, (US)

(72) Inventor: Ulrich Wiehsalla, Hamburg (DE)

(73) Assignee: MECOM MEDIEN-COMMUNIKATIONS-GESELLSCHAFT MBH, Hamburg (DE)

(21) Appl. No.: 13/800,021

(22) Filed: Mar. 13, 2013

Related U.S. Application Data
(60) Provisional application No. 61/611,630, filed on Mar. 16, 2012.

(51) Int. Cl. G08B 27/00

(52) U.S. Cl. CPC G08B 27/00
USPC 340/7.51

(57) ABSTRACT

The invention relates to a warning system and a method for operating a warning system. The warning system comprises a message issuer (14), a warning control center (18) and a multiplicity of message recipients (19). In the message issuer (14), a warning message (21) is generated in which is encoded a piece of geographical information. The warning message (21) is sent from the message issuer (19) to the warning control center (18) via a transfer station (15). In the warning control center (18), the geographical information is analyzed in order to make a selection from a multiplicity of predefined message recipients (19). The warning message (21) is sent from the warning control center (18) to the selected message recipients (19). The warning system according to the invention enables the warning messages (21) to be entered easily and enables rapid transfer of the warning messages (21) to the message recipients.

This application claims priority from U.S. Provisional Application No. 61/611,630 filed Mar. 16, 2012 for “Warning System and Method for Operating a Warning System”, the entire disclosure of which is hereby incorporated by reference.

### BACKGROUND

The invention relates to a method for operating a warning system comprising a message issuer, a warning control center and a multiplicity of message recipients. The invention also relates to a method for operating such a warning system.

Such warning systems can be used to warn the populace of dangers. One example is SatWas, the satellite-based warning system operated by the German Federal Office of Civil Protection and Disaster Assistance. A message issuer which is responsible for an area in which a danger situation arises generates a warning message and transfers it to a warning control center. From the warning control center, the warning message is transferred to message recipients, which can warn the populace. Message recipients within the meaning of the warning system can be, for example, broadcasting stations, sirens and similar means that can be used to reach the populace.

Known systems have the disadvantage of little flexibility. The warning messages are either sent to message recipients that have been defined in advance or else those message recipients that are meant to receive the warning message must be entered laboriously by hand.

### SUMMARY

An object of the invention is to present a warning system and a method for operating a warning system that provide greater flexibility in the transfer of warning messages. Proceeding from the prior art mentioned in the introduction, the object is achieved by the features of the independent claims. Advantageous embodiments are given in the subclaims.

In the method according to the invention, a warning message is generated in which a piece of geographical information is encoded. The warning message is sent from the message issuer to the warning control center via a transfer station. In the warning control center, a selection from a multiplicity of predefined message recipients is made on the basis of the geographical information. Then the warning message is sent from the warning control center to the selected message recipients.

The warning message is usually generated in a control center that is responsible for the area in which the danger situation has arisen. In the control center, a decision must be made on what the warning message is meant to contain and for whom the warning message is relevant. Usually the answer to the latter cannot be made without regard to the specific danger situation, because, for example in the event of an accident in a nuclear power station, the region in which the populace must be warned depends on the wind direction.

The intended recipients of the warning message are obtained by defining in the control center a specific geographical region for which the warning message is relevant. The geographical region can be defined, for example, on the basis of organizational units such as administrative districts or provinces for instance. It can also be defined on the basis of geographical reference points. If a geographical region is used for defining the circle of intended recipients, this has the advantage of great clarity. The warning message can then also be created reliably when the relevant personnel are under pressure.

The warning message is sent from the control center, which in this case is acting as a message issuer within the meaning of the invention, to the warning control center via a transfer station. In the warning control center, the piece of geographical information that is encoded in the warning message is analyzed in order to make a selection from a multiplicity of predefined message recipients. The message recipients that are selected are those that belong to the geographical region being addressed. The message recipients may be, for example, the broadcasting stations or other warning systems of the geographical region by means of which the warning message can be disseminated to the populace. Hence the invention has the advantage that the general definition of the circle of intended recipients of the warning message is separated from determining the specific message recipients. Thus the warning message can be generated easily in the control center by merely having to define a geographical region. The information about who the message recipients are in this geographical region is not added until in the warning control center. The system according to the invention therefore provides a high degree of flexibility without placing excessive demands on the originator of the warning message.

Both public networks and private networks are suitable for transmitting the warning messages. It is extremely important in the context of the invention, however, that the warning messages can also be transmitted with a high degree of reliability in crisis situations. This is not always guaranteed in public networks, because experience shows that in crisis situations there is an increased communications demand and therefore the public networks are often overloaded. Thus the transfer station is preferably a transfer station of a private network. In the private network, a communications channel is preferably provided that is intended solely for the purposes of the warning system according to the invention.

It is advantageous for data-transmission reliability if the transfer station is a satellite. Even a single satellite can be sufficient to act as the transfer station for all the stations involved in the transmission of the warning messages. The satellite can be positioned in a geostationary orbit. The provision of further transmission paths, such as the Internet or terrestrial radio networks for instance, in order to improve transmission reliability is not ruled out. Recourse to these transmission paths is possible if there is a fault in the link to the satellite.

For transmission of the warning messages from the warning control center to the message recipients, the transmission path can again be selected to be via the transfer station. Using a common transfer station for both transmissions of the warning message maintains clarity in the system.

The warning control center normally has a specific region of responsibility, which can correspond to a country or a union of countries, for example. A list containing all the message recipients in the region of responsibility is preferably provided for the warning control center. From these predefined message recipients, those message recipients for which the warning message concerned is intended are selected on the basis of the geographical information contained in the warning message.

Such a list makes it easier to associate automatically the geographical information in the warning message with the predefined message recipients. This can be done, for example, by each message recipient in the list being likewise associated with a piece of geographical information. A logic-based comparison can then be made between the piece of geographical information in the warning message and the pieces of geographical information belonging to the message recipients and contained in the list. In the event of a positive result of the comparison, the message recipient is added to the selected message recipients. Once the list has been processed in full, the warning message can be sent to all the selected message recipients.

An automated procedure of this type enables an extremely efficient transfer of the warning messages. Preferably, the length of time between the message issuer sending the warning message and the message arriving at the selected message recipients is less than 5 minutes, in addition preferably less than 1 minute, in addition preferably less than 30 seconds.

The geographical information can be encoded manually, for example by entering when creating the warning message a code assigned to the geographical region. This code could be an identification number of an administrative district, for instance. In an advantageous embodiment, the message issuer is designed to create the coding automatically from a piece of information provided graphically. This can be done, for example, by selecting a geographical region on a screen, and reading and encoding the relevant information. The graphical display on the screen can be configured such that specific geographical regions are preset for clicking on. Alternatively or additionally, it can be provided that the user selects an area in a map on a screen in a free configuration, and this information is encoded. For example, the user can select the region by drawing a line around the region. A graphical selection of this type is easier for the user to make than entering a code manually and thereby reduces the likelihood of mistakes.

All warning facilities that are suitable for transferring the warning to individual intended recipients or a plurality of intended recipients in the population are possible as message recipients within the meaning of the invention. A conventional warning facility in this sense are the broadcasting stations that can disseminate the warning message more widely via radio and/or television. Also possible as a message recipient is a local cellular phone cell via which all the cellular phones that are logged into the local cellular network can be messaged.

For the first alert, it can be sufficient to transfer merely a warning signal without the content of the warning message. Thus the message recipients can also include pure signaling devices such as sirens. It is also possible that the message recipients include those message recipients by means of which only a single person is warned. Cell phones, radio alarms, smoke alarms and the like, for example, can belong to this group.

In the warning system according to the invention, communications stations can be provided that can both generate and receive the warning messages, i.e. are message issuers and message recipients within the meaning of the invention. These may be situation centers, for example, which are generally responsible for danger situations. It can be provided that the warning message is sent to such communications stations irrespective of the geographical information, so that the communications station receives the warning message even when it does not lie in the geographical region for which the warning message is intended. An appropriate piece of information can be encoded in the warning message in addition to the geographical information. In the communications station, after receiving the warning message, warning messages particular to the communications station can be generated and sent to the message recipients in order to influence the further course of events. Preferably, the warning messages intended for the communications station or the warning messages coming from the combination center are also routed via the transfer station and the warning control center. If appropriate, the warning control center itself may also generate and send warning messages.

Owing to the simple structure of the warning system according to the invention, said system has the advantage of being able to link together sectors that hitherto have been completely separate from one another. The message issuers and the message recipients can stem, for example, from the governmental sector, the non-governmental sector, the military sector, the non-military sector, the public sector or the private sector.

The invention also relates to a warning system comprising a message issuer, a warning control center and a plurality of message recipients. The message issuer is designed to generate a warning message in which is encoded a piece of geographical information. The message issuer is designed to send the warning message to the warning control center via a transfer station. The warning control center is designed to select a plurality of message recipients on the basis of the geographical information. The warning control center is designed to send the warning message to the plurality of message recipients. The warning system can be enhanced by further features that are described with reference to the method according to the invention.

### BRIEF DESCRIPTION OF THE DRAWINGS

The invention is described below using advantageous embodiments by way of example with reference to the enclosed drawings, in which:

FIG. 1 shows a schematic diagram of a warning system according to the invention;

FIG. 2 shows an input screen for a message issuer according to the invention;

FIG. 3 shows the view from FIG. 2 for a different embodiment of the invention;

FIG. 4 shows a schematic diagram of a message issuer;

FIG. 5 shows a schematic diagram of a warning control center; and

FIG. 6 shows a schematic diagram of a warning message.

### DETAILED DESCRIPTION OF THE DISCLOSED EMBODIMENTS

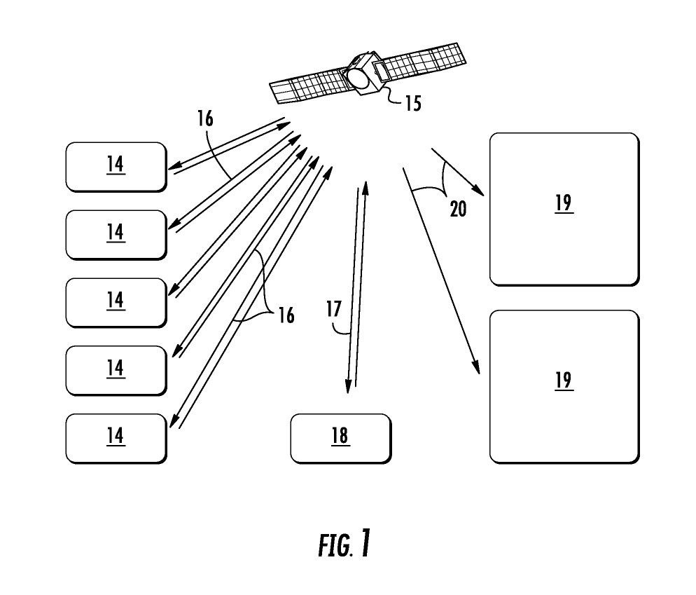

A warning system according to the invention is shown in FIG. 1 and comprises a plurality of communications stations 14, which are designed both to create and send warning messages (message issuers) and to receive warning messages (message recipients). The communications stations 14 may include, for example, control centers for a municipality, situation centers for the provinces, situation centers for the federal government, situation centers for multinational civil organizations, situation centers for the national military and situation centers for multinational military organizations. A bidirectional data link 16 to a geostationary satellite 15 is available for each of the communications stations 14. A further bidirectional data link 17 is provided between the satellite 15 and a warning control center 18. The satellite 15 forms a transfer station for data that is transmitted from the communications stations 14 to the warning control center 18 and in the opposite direction.

The warning system also comprises a plurality of message recipients 19 shown schematically. Between the satellite 15 and the message recipients 19 there is a unidirectional data link 20, which enables warning messages to be sent from the satellite 15 to the message recipients 19. The message recipients 19 can include a range of facilities, by means of which the warning message can be passed on to the populace. For example, the message recipients 19 can include radio and television transmitters, sirens, smoke alarms, pagers, weather stations (DCF77), cell phones, emergency services digital radio etc. Data transmission takes place over a private data link in which the required number of communications channels is reserved exclusively for the purposes of the warning system according to the invention.

If a danger situation that makes a warning to the populace necessary occurs in the area of responsibility of a communications station 14, a warning message is created in the communications station 14. A warning message 21, as shown schematically in FIG. 6, is a data structure comprising a plurality of information blocks 22, 23, 24, 25. The information block 22 contains the actual content of the warning message 21, which the operating person in the communications station 14 has entered, for example, via a keyboard. It is also possible that the text of the warning message 21 has already been stored for specific emergency situations and merely needs to be selected by the operating person. In the second information block 23 is stored a piece of information about the category of the warning message 21 which determines the priority with which the broadcasting stations, for instance, must handle the warning message 21.

Each communications station 14 that creates warning messages 21 is assigned one or more stations which must always be notified, i.e. must receive all the warning messages. These stations may include a higher-level situation center, for example. These stations are hard-programmed as message recipients into an address block 24 of the warning message 21.

In addition, the message recipients are determined on the basis of a piece of geographical information. For this purpose, when the warning message 21 is generated, a specific geographical region is defined for which the warning message 21 is relevant.

In the event of an accident in a nuclear power station, this would be, for instance, the region that lies downwind of the nuclear power station. The geographical information is entered by the operating person when the warning message 21 is created. The geographical information in the field 25 is stored in encoded form in the warning message 21.

Once creation of the warning message 21 is complete, the operating person issues a send command. The warning message 21 is then routed from the communications station 14 to the satellite 15, and from there to the warning control center 18. In the warning control center 18, the warning message 21 is received by a satellite antenna 26 and routed to an arithmetic unit 27, in which the geographical information is extracted from the warning message 21. The geographical information is then passed to a logic module 28. The logic module 28 accesses a memory 29 in which are stored all the message recipients 19 that lie in the region of responsibility of the warning control center 18. Each message recipient 19 is associated with a piece of geographical information which indicates in which region the populace can be warned by means of this message recipient 19. For a broadcasting station, for example, the geographical region would be the same as the transmission coverage.

The logic module 28 performs for each message recipient 19 that is stored in the memory 29 a comparison between the geographical information in the warning message 21 and the geographical information of the message recipient 19. If the comparison produces a positive result, this means that the message recipient 19 concerned is an intended recipient of the warning message 21. The logic module 28 is thus used to make a selection from all the message recipients 19 on the basis of the geographical information. Finally, the selected message recipients 19 are stored in the information block 25 of the warning message 21 instead of the geographical information.

If applicable, the priority information from the information block 23 is additionally analyzed, and is taken into account in determining the message recipients. A result of this can be, for example, that for a warning message 21 of lower priority, only the broadcasting stations are selected as the message recipients 19, whereas for a higher-priority warning message, sirens are also included in the message recipients 19.

The warning message 21 containing the added information on the intended recipients is then routed from the logic module 28 to the satellite antenna 26, and sent from there to the satellite 15. In the satellite 15, the information on the intended recipients is read from the information blocks 24, 25, and the message sent both to the hard-programmed message recipients 19 from the information block 24, and to the message recipients 19 from the information block 25, which were selected on the basis of the geographical information.

In the message recipient 19, the warning message 21 is dealt with further on the basis of the priority information from the information block 23. If the message recipient 19 is a broadcasting station, for example, for a warning message 21 of high priority, the broadcast program is interrupted for announcing the warning message. For a warning message 21 of lower priority, further editing of the message can take place and it can be incorporated in the broadcast program at a suitable time. If the message recipient is a local cellular phone cell, then the warning message can be sent to all the cell phones logged into the cellular phone cell.

For the warning system to work reliably, it is advantageous if the warning messages 21 can be entered via an interface that is as intuitive as possible. FIG. 2 shows an example of a screen display for entering a warning message in a computer 29 of a communications station 14. The input screen comprises a field 30, in which a title for the warning message 21 can be entered, and a field 31 for the actual content of the warning message 21. The priority of the warning message 21 can be set in a choice field 32, and a further choice field 33 provides the facility for specific selection of individual warning systems as the message recipients 19.

A window 34 containing a map display is provided for entering the geographical information. In the map display, regions are predefined that can be selected by clicking on. In the exemplary embodiment in FIG. 2, the selection applies to the two geographical regions shown shaded. Once the warning message 21 has been entered in full, the command to send the warning message 21 is issued by means of a button 35.

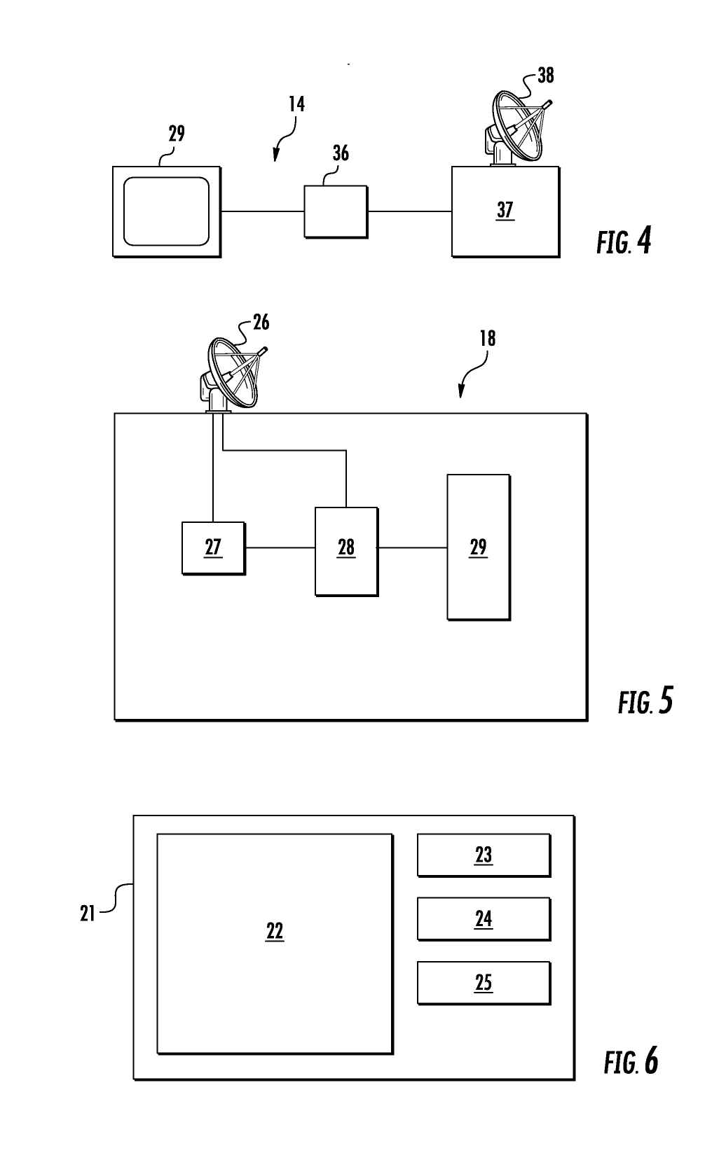

Still within the communications station 14, the warning message 21 is then routed from the computer 29 to an arithmetic unit 36, as shown in FIG. 4. Here, in the definition of the geographical region, which definition was only made graphically up to this point, a coding is created which is written into the information block 25 of the warning message 21. Then the warning message 21 is sent via a transmitter 37 and a satellite antenna 38 to the satellite 15.

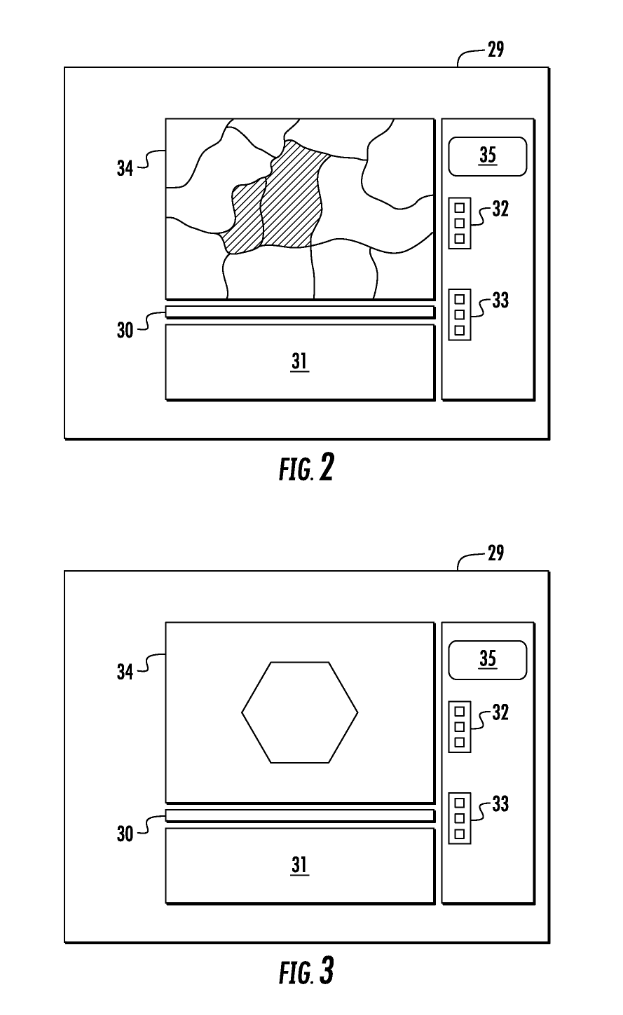

FIG. 3 shows an alternative example of an input screen for the computer 29. In the map display in the window 34, the required geographical region can be selected freely by drawing a line around the region using a mouse cursor. The arithmetic unit 36 can also create from this information in graphical representation a coding for the information block 25 of the warning message 21.

The warning messages 21 can thus be entered largely intuitively and hence also reliably in stress situations. Further processing of the warning messages 21 is carried out fully automatically, thereby enabling rapid transfer of the warning messages 21 to the message recipients 19.

What is claimed:

1. Method for operating a warning system comprising a message issuer (14), a warning control center (18) and a multiplicity of message recipients (19), having the following steps:
a. generating a warning message (21) in which is encoded a piece of geographical information;
b. sending the warning message (21) from the message issuer (19) to the warning control center (18) via a transfer station (15);
c. analyzing the geographical information in order to make a selection from a multiplicity of predefined message recipients (19);
d. sending the warning message (21) from the warning control center (18) to the selected message recipients (19).

2. Method according to claim 1, characterized in that the transfer station (15) is part of a private network.

3. Method according to claim 1, characterized in that the transfer station is a satellite (15).

4. Method according to claim 1, characterized in that the warning message (21) is sent from the warning control center (18) to the selected message recipients (19) via the transfer station (15).

5. Method according to claim 1, characterized in that the warning control center (18) is associated with a region of responsibility, and in that all message recipients (19) in the region of responsibility are stored in the warning control center (18).

6. Method according to claim 1, characterized in that the length of time between the message issuer (14) sending the warning message (21) and the warning message (21) arriving at the selected message recipients (19) is less than 5 minutes, in addition preferably less than 1 minute, in addition preferably less than 30 seconds.

7. Method according to claim 1, characterized in that the geographical information is encoded automatically on the basis of a piece of graphical information that is entered on a screen.

8. Method according to claim 1, characterized in that communications stations (14) are provided that comprise a message issuer and a message recipient.

9. Warning system comprising a message issuer (14), a warning control center (18) and a plurality of message recipients (19), having the following features:
a. the message issuer (14) is designed to generate a warning message (21) in which is encoded a piece of geographical information;
b. the message issuer (14) is designed to send the warning message (21) to the warning control center (18) via a transfer station (15);
c. the warning control center (18) is designed to select a plurality of message recipients (19) on the basis of the geographical information;
d. the warning control center (18) is designed to send the warning message (21) to the plurality of message recipients (19).

10. Method according to claim 2, characterized in that the transfer station is a satellite (15).

11. Method according to claim 2, characterized in that the warning message (21) is sent from the warning control center (18) to the selected message recipients (19) via the transfer station (15).

12. Method according to claim 3, characterized in that the warning message (21) is sent from the warning control center (18) to the selected message recipients (19) via the transfer station (15).

13. Method according to claim 2, characterized in that the warning control center (18) is associated with a region of responsibility, and in that all message recipients (19) in the region of responsibility are stored in the warning control center (18).

14. Method according to claim 3, characterized in that the warning control center (18) is associated with a region of responsibility, and in that all message recipients (19) in the region of responsibility are stored in the warning control center (18).

15. Method according to claim 4, characterized in that the warning control center (18) is associated with a region of responsibility, and in that all message recipients (19) in the region of responsibility are stored in the warning control center (18).

16. Method according to claim 2, characterized in that the length of time between the message issuer (14) sending the warning message (21) and the warning message (21) arriving at the selected message recipients (19) is less than 5 minutes, in addition preferably less than 1 minute, in addition preferably less than 30 seconds.

17. Method according to claim 3, characterized in that the length of time between the message issuer (14) sending the warning message (21) and the warning message (21) arriving at the selected message recipients (19) is less than 5 minutes, in addition preferably less than 1 minute, in addition preferably less than 30 seconds.

18. Method according to claim 4, characterized in that the length of time between the message issuer (14) sending the warning message (21) and the warning message (21) arriving at the selected message recipients (19) is less than 5 minutes, in addition preferably less than 1 minute, in addition preferably less than 30 seconds.

19. Method according to claim 5, characterized in that the length of time between the message issuer (14) sending the warning message (21) and the warning message (21) arriving at the selected message recipients (19) is less than 5 minutes, in addition preferably less than 1 minute, in addition preferably less than 30 seconds.

20. Method according to claim 2, characterized in that the geographical information is encoded automatically on the basis of a piece of graphical information that is entered on a screen.
